(19) United States
(12) Patent Application Publication
(10) Pub. No.: US 2009/0229627 A1
(43) Pub. Date: Sep. 17, 2009

(54) Oral hygiene and cosmetic enhancing apparatus with slideably-positionable member for protecting, concealing and revealing a mouth-area reflecting surface

(76) Inventors: Tracy G. Golden, Hidden Hills, CA (US); Donald J. Eslick, Culver City, CA (US)

Correspondence Address: Tracy G. Golden, 5822 Hilltop Road, Hidden Hills, CA, 91302, US

(21) Appl. No.: 12/075,280

(22) Filed: Mar. 11, 2008

(51) Int. Cl. A45D 42/10; A45D 42/00; A61C 15/00

(52) U.S. Cl. 132/288; 132/316; 132/328

(57) ABSTRACT

A portable oral hygiene and mouth-cosmetic enhancing apparatus for promoting oral hygiene and enhancing the cosmetic appearance of the teeth of users is disclosed, and the device includes: a thumb or digit positionable elongated member adapted to slideably fit within a casing and to be slideably positioned in a single plane or axis between a first closed position and a second outwardly extended position, having a concealable elongated surface area comprising material having a mirrored or reflective property, sized and shaped to reflect the area of a user's mouth when holding the device at approximately a typical reading distance. The apparatus provides one or more retaining elements which releasably retain one or more teeth-cleaning elements. Embodiments include casing-incorporated electronics such as memory storage or user-controllable electrically powered lighting mounted to direct light at the user's mouth and to optionally provide flashlight-like functionality.

### FIELD OF THE INVENTION

The present invention is related to the field of oral hygiene and cosmetic enhancing products. More particularly, the invention pertains to a portable handheld oral hygienic apparatus comprising a thumb or single-digit slideably positionable member which, when positioned in a first position protects and conceals a mirrored or reflective element surface, and when positioned in a second position reveals the reflective element surface and optionally provides an automated or manual switching of one or more illuminating elements such as electric lights or LEDs. Preferably, the apparatus also comprises one or more hygienically retained teeth-cleaning elements which can be selectively removed or replaced by a user such as one or more toothpicks, strands of dental floss, and the like.

### BACKGROUND OF THE INVENTION

The use of oral hygiene products in the privacy of one's home is a well-known practice. For hygienic purposes one or more of a few approaches are typically employed as an effective means for reducing the buildup of bacteria-producing matter on the surface of teeth, which is known to be a root cause of tooth decay and gum-related disease. For example, a daily-practiced oral hygiene regimen typically includes the use of a manual or electric toothbrush to brush one's teeth, in combination with the employment of one or more of the following: dental floss, a rubberized-tip tooth probe, mouthwash, a toothpick, and the like. It is widely known and generally accepted, that the more effectively food and bacteria are removed from the teeth throughout the course of a day, the more oral hygiene will be promoted and dental related problems or disease can be reduced.

Nonetheless, such regimens are difficult to replicate when one is out of the privacy of one's home, or traveling, at work, or in a public venue, such as a restaurant. Still, it is important to be diligent in the reduction of bacteria causing agents in the mouth when one is away from home. Accordingly, it would be useful to have a portable, easy-to-use oral hygiene enhancing device that could be used when one is not at home, and it is an object of the present invention to provide such devices to effectively address this need.

A related area of concern pertains to one's appearance and to cosmetic products serving an aesthetic purpose in beautifying the body. For example, it is quite common, following the eating of a meal or snack for one to have contents of the food remain on one or more teeth and to be unaware that the remaining food is visible to others. For some people, this experience can be quite embarrassing, particularly if one is shy or in the company of others that are new or unfamiliar to them. Consequently, it would be advantageous to have a portable device that could be used in a public restroom, or used discreetly in a public setting, that would make it easy to quickly see the area of one's mouth or one's teeth and to remove any food which is exposed on one's teeth.

Another problem with the status quo approaches is that some handheld reflective devices are equipped with mirrors which are unprotected or in an always-exposed state. Such products are not optimal because the mirrors or mirror elements can become easily dirtied, broken or damaged. Thus it would be advantageous to provide a product that allows a user to selectively control when and how much a mirror-element is exposed, and to be able to conceal the mirror-element in a protective manner quickly and easily when it is not needed.

Accordingly, it is another object of the invention to address such problems by providing a portable oral hygienic and mouth cosmetic handheld device, having a protected, slideably-concealable ample mirror or reflective surface element which is optimally sized, preferably having a concavity, which when held by a user at a comfortable distance (such as a typical reading distance or range) provides a mouth-wide or mouth-area reflection back to the user so that the user may employ one or more hygienically-retained teeth cleaning elements of the device to quickly and discreetly clean one's teeth.

Additionally, after eating, some food remnants can be particularly difficult to see if one is in an environment having little, poor, or a reduced lighting condition, and a cosmetic product having a mirror but no self-contained lighting source can be ineffective in reflecting back an adequate image to a user. Consequently, another object of the present invention is to provide one or more invention embodiments which include a power source and one or more switchable illuminating elements (such as one or more light bulbs or LEDs) located on the device so as to direct light over the mouth area when a user is looking at a reflected image of his or her mouth.

Another object of the invention is to provide a new type of cosmetic device which can be easily recognized as an elegantly simple, self-contained, reflective-element-protecting oral hygiene-enhancing product that includes user discernible content, or advertising content, or promotional content, or branding, or content having health and/or cosmetic enhancing value which is effective in creating a desired mental association between a user and a major cosmetic company, or a major dental product producing company, or an advertising campaign, and the like. Such content may also include a name which enhances one or more of such associations such as SmileCheck™ which is common law trademarked name currently employed by the two applicants of the present patent application.

### SUMMARY OF THE INVENTION

The self-contained and portable oral hygiene and mouth cosmetic enhancing apparatus of the present invention comprises a body or casing made of a rigid or semi-rigid material in which a slideably-positionable member for protecting, concealing and revealing a mouth-wide reflecting or mouth-area reflecting surface element or mirror is slideably operative within a single plane by a thumb or single-digit of a user. When the slideably positionable member is positioned in a first or closed position, the reflecting surface element or mirror surface, which is sized to extend up to, or nearly up to, the length and width of the apparatus casing, is concealed, and protected from damage, and from gathering dirt, finger smudges or other unwanted material, and when the member is positioned in a second or opened position, the reflective element or mirror surface, is revealed. In one embodiment, the single-plane slideably-positionable member is located above a reflective element or mirror surface housed within the apparatus body or casing, which is fully revealed when the member is slid along a longitudinal axis to its full-open position, and preferably includes a friction-inducing textured, or ribbed, or detented, or indented surface on an upper surface of the member which facilitates positive engagement with a user's thumb (or one or more other fingers). In a second embodiment, the single-plane slideably-positionable member has an upper surface reflective element or mirror surface and is slideably positionable within the apparatus body or casing so as to fully reveal the member and reflective element or mirror surface when the member is slid along a longitudinal axis to its full-open position, and preferably includes a friction-inducing textured, ribbed or detented knob extending outwardly from a side of the member which facilitates positive slide-inducing engagement with a user's thumb (or one or more other fingers). In a third embodiment, the single-plane slideably-positionable member has an upper surface reflective element or mirror surface and is slideably and rotationally positionable within the apparatus body or casing so as to fully reveal the member and reflective element or mirror surface when the member is rotated to its full-open position, and preferably includes a rotation-inducing lever extending outwardly radially from a hinge point from a side of the member which facilitates positive rotation-inducing engagement with a user's thumb (or one or more other fingers). It is noted that while the latter embodiment describes a single-plane rotationally-positionable member having a reflective element or mirrored surface, that alternatively, it is also possible to incorporate the reflective element or mirror surface within the apparatus body or casing (as described in the first embodiment) which is fully revealed when a rotationally positionable (non-mirrored) member is rotated to its full-open position.

In each embodiment, the reflective element or mirrored surface is comprised of one or more reflective material including any in a variety of materials from which mirrors or reflective surfaces are made, such as one or more of the following materials: glasses, plastics, paints, a plastic foil material, a Mylar foil material, a metallic foil material, and the like.

Preferably the (normally-protected and concealed) reflective element or mirrored surface of the apparatus is sized and shaped to provide an ample, easy-to-see mouth-wide or mouth-area reflected image to a user when held by the user at a comfortable viewing distance, such as a typical reading distance or range, and such that the reflected image is in focus to, or easily focused on by, the user. For example, the shape of the reflective element or mirrored surface can include a fixed concavity or bendable magnifying element. For example, in the latter case, the reflective element of the apparatus can be made of one or more flexible materials wherein a manual bending of the element causes an increased concavity, such as (i.) a user pushing inwardly, longitudinally on one or both ends of the element causing it to flex or arc, or (ii.) by a user pushing on a central area of the reflective element inwardly, perpendicular to its longitudinal axis, such that, in either case the concavity of the element can be selectively determined or increased as needed by the user. For further variable-magnification control the reflective element can include one or more retaining elements (such as notches, teeth, indents or detents or the like) which can be positioned by the user to interact with one or more corresponding retaining elements so as to temporarily or releasably retain the bendable reflective element at one or more desired magnifications.

In each case the present apparatus provides a slideably-positionable enclosure-protected reflective element having an optimum fixed or variable magnification range for providing a mouth-wide or mouth-area reflected image to the user when held at a comfortable reading distance or range. For example, a fixed or flexible magnification element can include a particular magnifying factor (e.g., 200% or 300%) or provide one or more magnifying factors within an optimal range such as 200%-500% range, or typical of various types or magnification-ranges of reading glasses. Alternatively or additionally, the present apparatus can be provided in various models wherein a user having glasses with a particular magnification (such as reading glasses) can select a product model whose reflective element or mirrored surface has the same, similar, or a complementary magnification, and a user having glasses with a different magnification can select a product model suited to the magnification of their glasses, and so on. Optionally, the present invention may provide any among a variety of various enclosures made of, or having the appearance of, any among a wide range of materials and aesthetic designs, and any of such enclosures may be adapted to accept any among the aforementioned types of reflective elements. Thus an owner of one of the apparatus enclosures of the present invention can seek out the type of reflective element best suited for their needs, including picking a fixed element magnification or variable magnification of their choosing, and then simply slide the element into the enclosure of their choosing.

The present invention also provides the option to equip the apparatus enclosure so as to provide users with a compact multifunctional device that provides functions in addition to the previously described oral hygiene and cosmetic purposes. For example, the enclosure can include, incorporate, be equipped with, integrally formed with, or made to adjoin with a relatively small electronic device such as a storage memory or communication device that can communicate via a wireless or physical connection with a computer or handheld communication device (e.g., smart phone, cell phone, PDA, audio player, MP3 player, GPS device, and the like). Preferably the incorporation of any of such small electronic devices (not illustrated), include devices that are similar in one or more dimensions with the enclosure to which they are each paired so that the apparatus enclosures remain compact, easy-to-use and quite portable. Thus, the enclosure of the present invention can include or incorporate a small memory card, Flash memory, USB memory, memory stick or the like, or other small electronic components, which can easily be connected with or communicate with a computer or transportable handheld device.

In each case, the apparatus enclosure also includes a reflecting surface element or mirrored surface element, which may be sized dimensionally to extend up to, or extend nearly up to, the length, or width, or both, of the apparatus enclosure or casing; which preferably provides a mouth-wide or mouth-area reflected image to a user; and which may be concealed, protected from damage, and from gathering dirt, finger smudges or other unwanted material, until it is selectively revealed by a user-positioning of the element within a single axis or plane.

In one embodiment of the invention the apparatus includes the option to incorporate a power source and one or more illuminating elements or lights whereby the apparatus enclosure can also function as a light source. For example, the apparatus may provide a self-illuminating automated switching mode or an alternative manual switching mode, wherein, in each case, one or more illuminating elements such as electric lights or LEDs (or the like) can be selectively turned on and off by the closing and opening respectively of an electrical circuit, which when selectively closed or completed includes an electrical empowering from an electrical power source meeting a specified electrical requirement of the element(s). Each illuminating element or a combination of elements employed is located, mounted and positioned so as to direct light over the mouth area when a user is looking at a reflected image of his or her mouth. In the self-illuminating automated switching mode, the apparatus is equipped with the aforementioned circuit, and the circuit remains open or incomplete until the slideably-positionable member of the apparatus is moved in a reflective surface revealing or mirror revealing direction, or when the member is moved to, or past, a predetermined point. For example, adjacent or proximate to an innermost end of a slideably-positionable member of the present apparatus a transversely-arranged electrically conductive material can be mounted, and the casing or body of the same apparatus can be equipped with two separate but opposing electrical circuit leads which are contacted by the electrically conducted material to cause a closing or completing of the circuit when the slideably-positionable member is moved to, or within, or beyond, a predetermined point or range, such as a fully opened position or moved in an opening direction. Optionally the same circuit can also include a manual electrical switch which can be employed for example, during daylight hours or in well-lit environments when electrical lighting is not needed and thereby provide a means for saving electrical power. Similarly, in a manual electrical switching mode, the electrical circuit of the apparatus can include a manual electrical switch which can be employed by a user to selectively either: cause a closing or completing of the circuit when lighting is required, or cause an opening or cessation of the circuit when no lighting is needed. Additionally, any in a variety of commercially available electrical switches can be employed, including, but not limited to, one or more of the following switch types: push button switches, toggle switches, slideable member switches, momentary-on switches, DIP switches, recessed switches, light-intensity sensitive switches, switches concealed from view for example when the slideably-positionable member of the apparatus is in a closed position, and the like. In the embodiments including one or more illuminating elements, an electrical circuit empowering source is provided such as any one or more of the following: batteries, re-chargeable batteries; solar cells, and the like (or any combination thereof). In the event when one or more disc-like batteries are employed by any of the present apparatus, one or two opposite side walls of the casing or body of the apparatus can be enlarged proximate to the battery(s) to accommodate the round perimeter of the battery(s). Alternatively or additionally, the same or similar shape, or one or more ribs, detents or indents (or the like) can be included on one or opposite sides of the apparatus to provide added grip and/or tactile feedback to a user as to the current orientation of the apparatus. For example, when any of such surface or side embellishments are integrally located proximate to the portion of a slideably-positionable member (or outward-extending knob thereof) intended to be engaged by a user's thumb or one or more fingers, the apparatus can be felt and then be easily manipulated and orientated to a normally operable position without having to be seen by a user.

Preferably, the apparatus also comprises one or more concealed and/or hygienically retained teeth-cleaning elements such as one or more: toothpicks, strands of dental floss, and the like. For example, the apparatus can be equipped with one or more receptacles, or sheaths, or concealable cavities or retainers for retaining one or more toothpicks (made of a rigid or semi-rigid material) which can be selectively removed therefrom and re-inserted therein by a user, or be selectively removed and re-attached by a user to one or more toothpick clips or concealable toothpick retainers. Similarly, one or more strands or lengths of dental floss can be retained within the apparatus, for example, by being wrapped around two opposing dental floss retainers or clips, or by alternatively being wrapped around a portion of the slideably-positionable member, and in each case, be optionally concealable within the apparatus body or casing when the slideably-positionable member is in a closed position.

Finally other features of the present invention will become obvious to the reader and it is intended that these features be within the scope of the present invention.

Advantages of the invention will be set forth, in part, in the description that follows and, in part, will be understood by those skilled in the art from the description or may be learned by practice of the invention. The advantages of the invention will be realized and attained by means of the elements and combinations particularly pointed out in the appended claims and equivalents.

### BRIEF DESCRIPTION OF THE DRAWINGS

FIGS. 1 and 2 are a three-dimensional depiction of an embodiment of the present invention having a slideably-positionable member which is slideably operative in a single plane in a casing or body of the apparatus, and in FIG. 1 is depicted being slid to a closed position which conceals an internal reflective surface or mirrored surface, and in FIG. 2 is depicted being slid to an opened position which reveals the internal reflective surface or mirrored surface. FIGS. 2 and 3 further illustrate optional elements including an attachment means adjoining a rear end of the apparatus, rounded side detents, upper ribbed or textured friction-inducing surface, and the incorporation of an optional electrical illuminating element such as a light or LED.

FIGS. 3 through 8 are two-dimensional views of the embodiment depicted in FIGS. 1 and 2, wherein in FIG. 3 a top view of the apparatus is depicted with the slideably-positionable member shown in an extended position as in FIG. 2. In FIG. 4, an outer end view is depicted. In FIG. 5, a top view of the apparatus is depicted with the slideably-positionable member shown in a closed position as in FIG. 1. FIG. 6 is a bottom view and FIG. 7 is a side view with the slideably-positionable member shown in a closed position as in FIG. 1, and FIG. 8 is a side view with the slideably-positionable member shown in an extended position as in FIG. 2.

FIGS. 9 and 10 are a top view and side view respectively of a stylus-like toothpick which is insertable into and removable from a toothpick receptacle of the apparatus.

FIGS. 11 through 20 are two-dimensional depictions and views similar to those of FIGS. 3 through 8 wherein the single-plane or single-axis slideably-positionable member of the apparatus has a side which incorporates a reflective or mirrored surface, or an integrally formed mirror, and a knob extending outwardly from the member to facilitate user positioning of the member, wherein the member is fully concealable within the apparatus body or casing when moved to a closed position as depicted in the side view of FIG. 16, the top view of FIG. 18 and the bottom view of FIG. 20. FIGS. 11 through 13 are side views illustrating optional apparatus elements comprising a clip or attachment means adjoining a rear end of the apparatus, and optional elements being incorporated into the slideably-positionable member, wherein in FIG. 11 the member has two electrically illuminating elements, in FIG. 12 the member has two lower dental floss clips or retainers around which one or more strands or lengths of dental floss are wrapped, and in FIG. 13 the member alternatively has a concealable cavity in which one or more toothpicks can be stored and removed by a user. FIG. 14 is a bottom view of the apparatus depicted in FIG. 13 wherein the member is shown in cross-section to illustrate how an indent in the toothpick cavity facilitates an exposing of a retained toothpick by a user pressing down on one end of a stored toothpick. FIGS. 15 and 16 are an end view and side view respectively depicting what the apparatus looks like when each member of the apparatus depicted in FIGS. 12 through 14 is moved to a closed position. FIGS. 17 and 18 are top view depictions of the apparatus of FIGS. 15 and 16, and FIGS. 19 and 20 are bottom view depictions of the apparatus of FIGS. 15 and 16.

FIGS. 21 through 25 are two-dimensional views depicting an embodiment of the invention having a slideably-positionable member which is rotatably positionable in a single-plane and further depicts an optional detachable toothpick element in the side views of FIGS. 21 and 22 retained by two clips adjoining a lower edge of the member concealable when the member is rotated to a closed position. FIG. 23 depicts the member having two illuminating elements. FIGS. 24 and 25 are a side view and top view respectively of either apparatus depicted in FIGS. 21 or 23. FIGS. 21, 23 and 24 also depicted the use of user discernible content or advertising or promotional content on an exterior, viewable surface of a portable oral hygiene enhancing product.

### DETAILED DESCRIPTION OF THE PREFERRED EMBODIMENTS

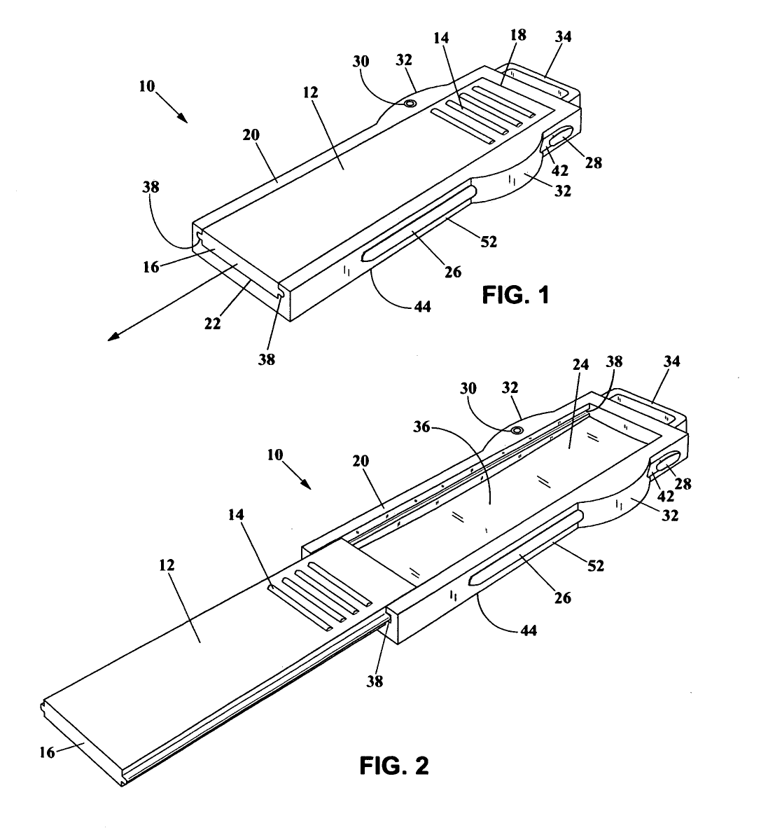

In reference to FIGS. 1 and 2, an embodiment of the present invention 10 is depicted having a slideably-positionable member 12 which is slideably operative in a single plane in a casing 20 or body of the apparatus. For example, parallel opposite outer edges of the member can each have one or more longitudinal ridges that are coaxially positionable within an equal number of respective channels 38 as depicted in FIGS. 1 and 2, and the member may be further equipped with one or more stops (not shown) which keep the member from slipping or being positioned beyond casing end 22. Preferably, an upper surface area of slideably-positionable member 12 proximate to an inner end 18 of the member includes a thumb or digit engaging texture or member textured contour 14 such as a series of parallel ribs or detents, or alternatively one or more indentations or other friction-enhancing surface, texture or contour, whereby a user can easily engage the contoured surface area in order to facilitate the sliding of slideably positionable member 12 in the direction indicated by the arrow-tipped black line extended outwardly from outer end 16 of the member. As can be seen in the end view of FIG. 4 and casing apertured end 56 thereof, wherein the width of member 12, outer end 16 thereof and member textured contour 14 are depicted being orientated in a vertical axis in the figure, the outermost opposite side edges of member 12 can be shaped to slideably fit within and be retained by channels 38 of apparatus casing 20 such that member 12 is outwardly and inwardly positionable next to mirrored or reflective surface area 24 (or a concave surface area 36 thereof) via casing-end opening 22.

As can been seen in FIG. 2, when slideably-positionable member 12 is in a opened position, the member reveals a normally protected internally located mirrored or reflective surface 24 which can be dimensioned in length or width, or both, up to, or nearly up to, the length, or width, or both, of the apparatus casing 20. As can been seen in FIG. 1, when slideably-positionable member 12 is slid to a closed position, the member conceals the internal mirrored or reflective surface 24 and protects the surface from damage, dust, dirt, debris, smudges, fingerprints, food, and the like. Preferably the reflective surface has a concavity or concave surface 36, whereby a mouth-wide or mouth-area image of a user is reflected back to the user when the apparatus is held at a comfortable distance or range in front of the user such as a typical reading distance or range. The maximum or optimal dimension of the reflective surface 24 relative to the size of the apparatus casing 20 facilitates quickly finding and centering a mouth-area reflected image back to a user.

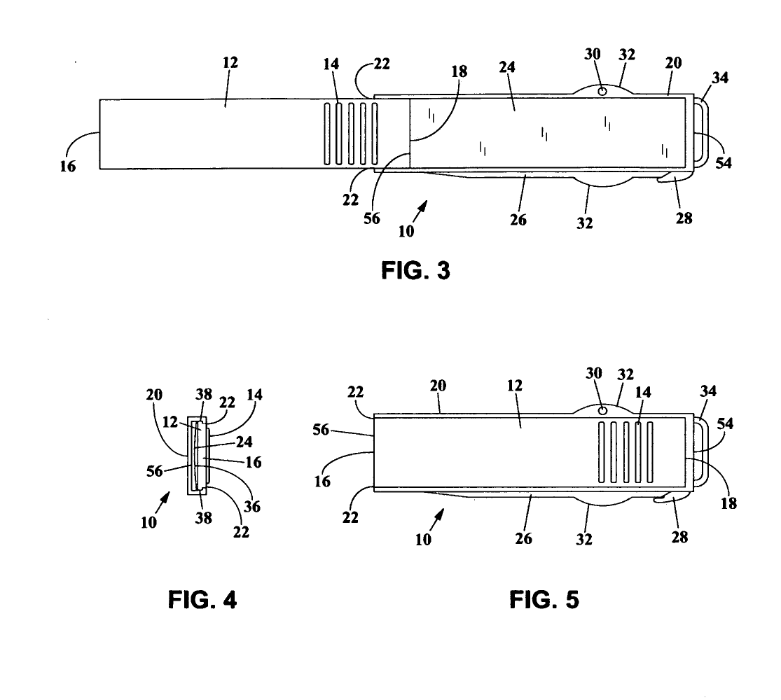

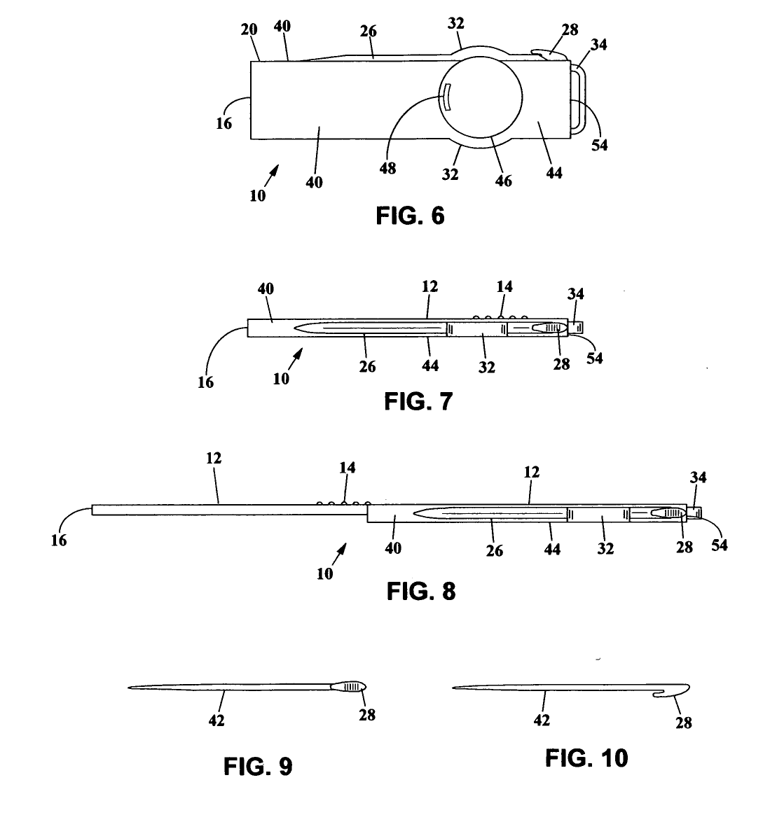

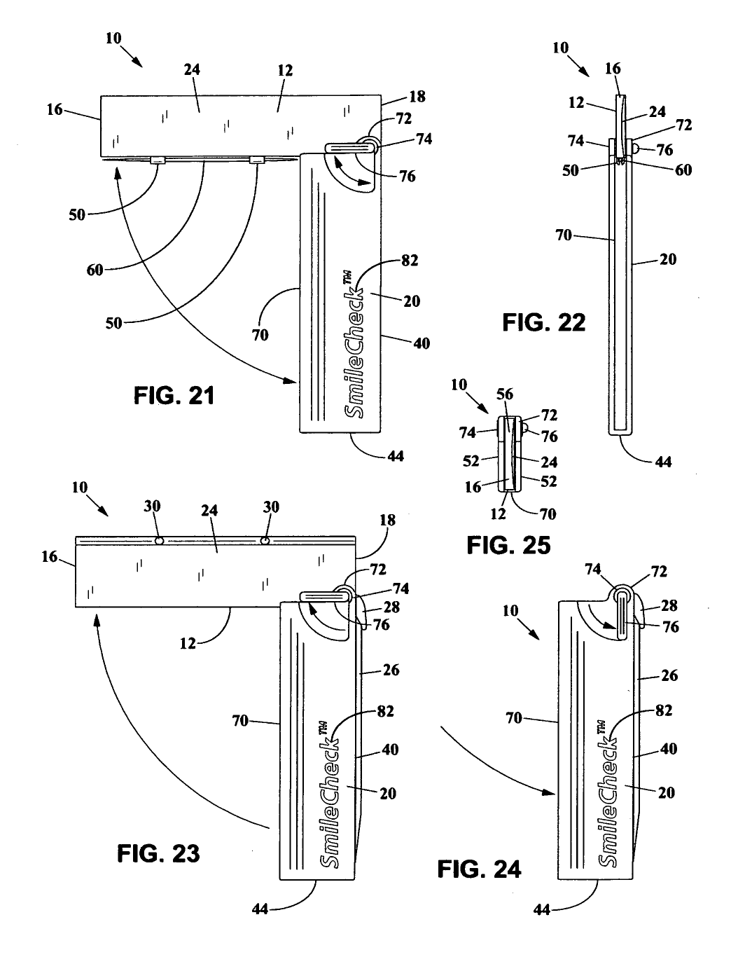

FIGS. 2 and 3 further illustrate optional elements including an attaching means 34 adjoining a rear end 54 portion of the apparatus (seen in FIG. 3) suitable for securely and releasably attaching the apparatus to fastening means such as a clip, clasp, tie, keychain, retractable cord or cable, and the like, thus keeping the apparatus close at hand and preventing the apparatus from becoming lost. FIGS. 2 and 3 also depict optional rounded casing side contours 32 (also depicted in FIGS. 1-3, and 5-8) which provide users a tactile means of sensing the orientation of the device, for example, when felt inside one's pocket, or in one's hand including when one is in a dark or poorly lit environment. Contours 32 can also be employed to optimally accommodate the use of one or more disc-shaped batteries for example when any of the latter are inserted into a battery aperture 46 accessible via battery aperture cover 48 depicted in FIG. 6. Preferably the apparatus is equipped with one or more electrical illuminating element(s) 30 such as a light or LED (e.g., as depicted in FIGS. 1, 2, 3, 5, 11, 17 and 23) which, when turned on, facilitates a user seeing his or her mouth area when the user is in a dark or poorly lit environment, and optionally also provides the added advantage of functioning as a small handheld flashlight, for example when the device includes an easily accessed on-off switch, or momentary-on switch, or other electromechanical switching means, and the like (such as any one or more of the switching means described elsewhere in this specification). In the embodiments incorporating one or more illuminating elements such as lights or LEDs, the element(s) are mounted so as to direct light at the mouth-area of a user when the apparatus is held at an orientation such that the mouth area of the user is seen in the mirrored or reflective surface area 24 of the apparatus. Preferably each embodiment of the invention includes at least one toothpick receptacle 26 (e.g., as seen in FIGS. 1 and 2 located above apparatus casing bottom 44), or retaining means, or cavity(s), into which at least one toothpick or toothpick-like element 42 (e.g., having an optional stylus-like end 28 as depicted in FIGS. 1-3, 5-12, 23 and 24) can be inserted. In each case, the apparatus-retained or contained toothpick(s) is stored, retained or contained in a secure, sanitary manner and facilitates easy and quick user access. In one mode, a toothpick 42 or toothpick-like element is simply inserted into an externally accessible aperture of a toothpick receptacle 26 (e.g., as depicted in FIGS. 1-3, 5-8 and 11, 12, 16, 23 and 24). In another mode, one or more toothpick(s) are storable within a normally concealed and protected cavity or recessed area located in a portion of slideably-positionable member 12 (or located internally in a concealable portion of the apparatus casing) such as recessed toothpick receptacle 26 e.g., as depicted in FIGS. 13 and 14. In another mode, one or more toothpicks are releasably attachable to one or more concealable toothpick retainers 50 (e.g., as depicted in FIGS. 21 and 22) adjoining an edge of slideably-positionable member 12 and providing easy toothpick access to a user when member 12 is slid to a opened position, and fully concealing the toothpick(s) in a sanitary manner when member 12 is slid to a closed position e.g., as depicted in FIG. 24.

In operation, in reference to the embodiment depicted in FIGS. 1-8, slideably-positionable member 12 is moved or positioned from a normally closed, mirrored or reflective surface protecting position (e.g., as depicted in FIGS. 1, 5 and 7) by a user sliding the member to its extended position (as depicted in FIGS. 2, 3 and 8), for example, by engaging member textured contour 14 and pushing (or pulling) the member in an outward direction with one's thumb and/or one or more other fingers. When the member is fully extended, the normally protected reflective surface area 24, preferably optimally dimensioned to approximate the length and width of the apparatus casing 20, is revealed and ready for use as an optimum mouth-area reflecting component or element of the apparatus, which the user preferably holds at, or within, a comfortable or typical reading distance, such that the area of the user's mouth is clearly and easily seen in, and simply reflected and/or magnified to extend nearly up to the full length of the mirrored or reflective surface area 24. When the user sees his or her mouth area so reflected, one or more of the teeth-cleaning elements of the apparatus can then be employed to clean, and/or cosmetically improve the appearance of, the user's teeth (e.g., by employing one or more aforementioned toothpicks, toothpick-like elements and/or one or more strands or lengths of dental floss). Following the use of one or more of the aforementioned teeth-cleaning elements, the apparatus provides the user the option to store any of such elements (as previously stored or retained by the apparatus) or to dispense any element which is disposable and economically replaceable. In either case, the slideably-positionable member 12 can then be moved or positioned to a normally closed, mirrored or reflective surface protecting position (e.g., as depicted in FIGS. 1, 5 and 7), and returned to one's pocket, purse or other transporting mode preferred by the user.

For ease of reference, the drawing figures (FIGS. 1-25) replicate most or all of the aforementioned drawing reference numerals and thereby, the reference numerals can be easily cross-referenced between one or more of the previous and remaining figures.

FIGS. 9 and 10 are a top view and side view respectively of a stylus-like toothpick which is insertable into and removable from a toothpick receptacle of the apparatus in a manner as previously described.

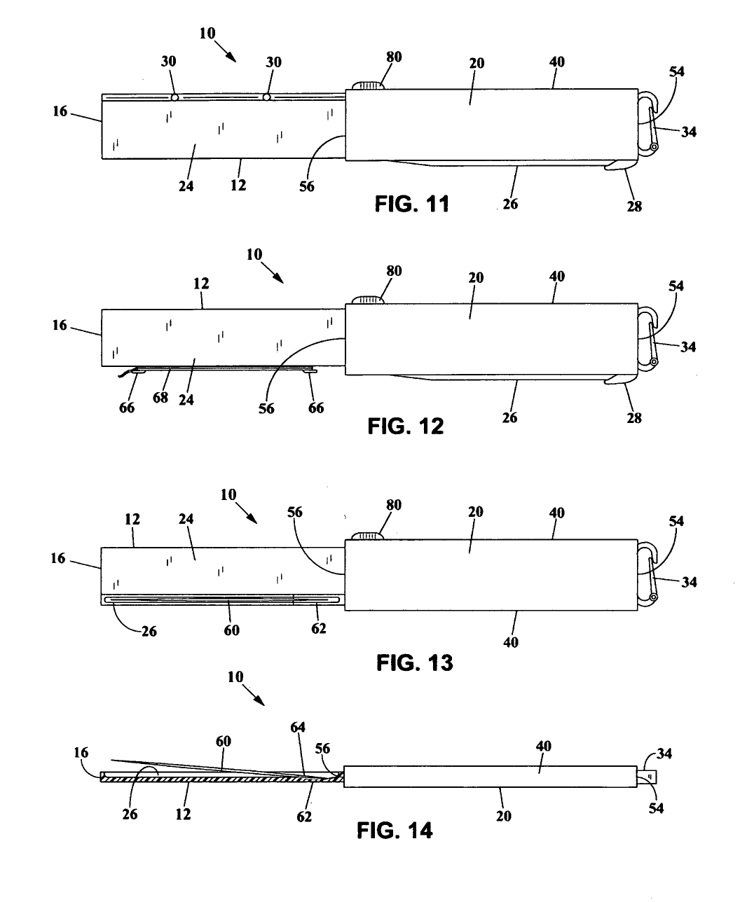

With respect to FIGS. 11 through 20, a similar embodiment of the invention is depicted, wherein a mirrored or reflective surface 24 is integrally formed into, laminated onto, or adapted to adjoin, at least one larger side of a slideably-positionable member 12 (e.g., as depicted in FIGS. 11-13) and which is preferably fully concealable and protected from damage, dust, dirt, debris, smudges, fingerprints, food, and the like, when member 12 is positioned to a closed position as depicted in the side, top and bottom views of FIGS. 16, 18 and 20 respectively. Member 12 preferably includes a tab or knob 80 having a portion adjoining member 12 which extends through an aperture or slot 58 of casing 20 (e.g., as depicted in FIGS. 11-13 and 15-18) so as to provide a positionable element which is easily engaged by a thumb and/or one or more fingers of a user, whereby member 12 can be positioned in a manner similar to those previously described in reference to any of FIGS. 1-8. Accordingly, the mirrored or reflective surface 24 on at least one larger side of slideably-positionable member 12 is concealable in part or entirely within the apparatus body or casing when moved by user positioning of the tab or knob to a closed position as depicted in the side view of FIG. 16, the top view of FIG. 18 and the bottom view of FIG. 20. Conversely, the mirrored or reflective surface 24 on slideably-positionable member 12 is revealed a ready for use when a user positions the tab or knob adjacent or proximate to casing apertured end 56 as depicted in the side views of FIG. 11-13, the top view of FIG. 17 and the bottom view of FIG. 19.

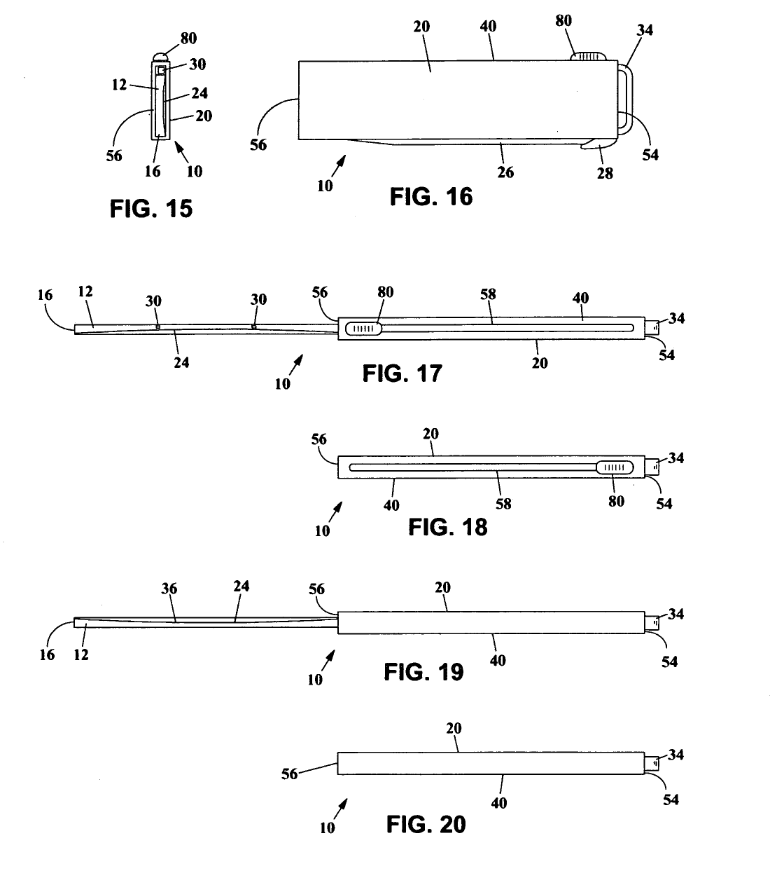

The side views of FIGS. 11 through 13 further illustrate optional apparatus elements comprising a clip or releasable attachment means 34 adjoining a rear end of the apparatus, and optional elements being incorporated into or adjoining slideably-positionable member, wherein in FIG. 11 slideably-positionable member 12 is depicted having two electrically illuminating elements 30, in FIG. 12 member 12 is depicted having two lower dental floss clips or retainers 66 around which one or more strands or lengths of dental floss 68 are wrapped, and in FIG. 13 member 12 alternatively is depicted having a fully concealable and protected cavity in which one or more toothpicks can be stored and removed by a user. FIG. 14 is a bottom view of the apparatus depicted in FIG. 13 wherein member 12 is shown in cross-section to illustrate how an indented portion of the member and toothpick cavity (receptacle 26) facilitates an exposing of one end of the retained toothpick by a user pressing down on the opposite end of the toothpick. FIGS. 15 and 16 are an end view and side view respectively depicting what the apparatus looks like when member 12 of the apparatus depicted in FIGS. 12 through 14 is moved to a closed position. FIGS. 17 and 18 are top view depictions of the apparatus of FIGS. 15 and 16, and FIGS. 19 and 20 are bottom view depictions of the apparatus of FIGS. 15 and 16. While the illuminating elements 30 of FIG. 11, dental floss 68 and floss retainers 66 of FIG. 12, and toothpick receptacle 60 of FIGS. 13 and 14 are depicted as having a particular location, it is noted that numerous other arrangements are also possible and that the drawings are illustrative and not intended to be exhaustive. For example, one or more lights or LEDs can alternatively be located on casing 20 of the apparatus, or one or more strands or lengths of dental floss can alternatively be wrapped around a reduced portion or diameter of slideably-positionable member 12, or a toothpick cavity-receptacle can alternatively be located in concealed manner within casing 20 and have a hinged cover which can be opened and securely closed by a user, and so on.

FIGS. 21 through 25 are two-dimensional views depicting an embodiment of the invention 10 having a slideably-positionable member 12 which is rotatably positionable in a single-plane and further depicts an optional detachable toothpick element or toothpick 60 in the side views of FIGS. 21 and 22 retained by one or more toothpick retainers 50 adjoining a lower edge of the member such that the toothpick and retainer(s) are fully concealable in a sanitary manner when member 12 is rotated to a closed position. Alternatively, member 12 can be equipped with a toothpick receptacle, for example, adjoining a lower edge of the member which is concealable when member 12 is rotated to a closed position. FIG. 23 depicts member 12 having two illuminating elements which are concealable when member 12 is rotated to a closed position. FIGS. 24 and 25 are a side view and top end view respectively of either apparatus depicted in FIGS 21 or 23. FIGS. 21, 23 and 24 also depicted the use of user discernible content 82 such as a brand name, advertising or promotional content on an exterior surface of a portable oral hygiene enhancing product which is viewable when a user is employing the apparatus. Preferably, slideably-positionable member 12 is rotatably positionable around a hinge 74 for example located in a pair hinge flange members 72 and optionally includes a positioning lever 76 to facilitate a rotational or pivoting positioning of member 12 within a single plane. In operation, a user can engage lever 76 with a thumb or finger(s) and rotate the lever from a positioning depicted in FIG. 24 or 25 to a positioning depicted in FIGS. 21-23 to fully expose the mirrored or reflective surface 24 of member 12. Conversely, a user can engage lever 76 with a thumb or finger(s) and rotate the lever from a positioning depicted in FIGS. 21-23 to a positioning depicted in FIG. 24 or 25 to fully close the mirrored or reflective surface 24 of member 12. Preferably, the casing 20 of the apparatus incorporates a toothpick receptacle 26 when member 12 does not include a toothpick retaining means. While member 12 has been described being rotationally positionable in a single plane by various positionings of lever 74, it is noted that member 12 can alternatively be rotated by other means, for example, member 12 can include a flange or tip which extends slightly beyond casing 20 and which facilitates engagement by a thumb or finger(s) of a user and rotational positioning of the member, and/or casing 20 of the apparatus can include one or more indentations which facilitate positioning of member 12 in a pocketknife fashion, and so on.

Accordingly, the highly portable, self-contained apparatus of the present invention promote general oral hygiene, bacterial suppression, tooth decay prevention, and enhance the cosmetic appearance of the teeth and mouth of their users, and preferably do so by equipping such apparatus with one or more electrical illuminating elements whereby users can enjoy and benefit from the aforementioned benefits and advantages of the apparatus in environments having little or no lighting.

What is claimed is:

1. An oral hygiene and mouth-cosmetic enhancing apparatus comprising:
a positionable elongated member made of a rigid or semi-rigid material, adapted to slideably fit in a casing and to be slideably positioned within a single plane or axis between a first closed position and a second outwardly extended position, having a length extending up to the length of the casing;
a concealable elongated surface area of said apparatus having a width extending up to the width of the casing and a length extending up to the length of the casing, and said surface area comprising at least one material having a reflective property;
said positionable elongated member slideably positionable to extend outward from said casing to said second outwardly extended position to reveal up to all of said elongated surface area, and slideably positionable to said first closed position to protect and conceal the elongated upper surface.

2. The oral hygiene and mouth-cosmetic enhancing apparatus of claim 1 wherein said concealable elongated surface area and said at least one material thereof are located on a side of said positionable elongated member.

3. The oral hygiene and mouth-cosmetic enhancing apparatus of claim 2 wherein said concealable elongated surface area and said at least one material thereof have a concavity causing the width of a user's mouth to be reflected back to the user when said surface area is pointed in the direction of the user's face and said apparatus is also held at approximately a typical reading distance.

4. The oral hygiene and mouth-cosmetic enhancing apparatus of claim 1 wherein said concealable elongated surface area and said at least one material thereof are located on an interior portion of said casing which is concealed in a first position and revealed in a second position by slideably positioning the positionable elongated member within a single plane or axis.

5. The oral hygiene and mouth-cosmetic enhancing apparatus of claim 1 further comprising said casing being adapted to accept different removable and re-insertable positionable members each having a concealable elongated surface area having a width extending up to the width of the casing and a length extending up to the length of the casing, and positionable members being selectable from members made of a rigid material having a reflective surface area with a fixed magnification, or made of a flexible material having a reflective surface area which can be shaped by a user to provide a plurality of magnifications.

6. The oral hygiene and mouth-cosmetic enhancing apparatus of claim 1 further comprising at least one removable and re-insertable toothpick-like member.

7. The oral hygiene and mouth-cosmetic enhancing apparatus of claim 1 further comprising at least one removably attachable toothpick which is fully concealed in a sanitary manner within said casing when said positionable elongated member is positioned to said closed position.

8. The oral hygiene and mouth-cosmetic enhancing apparatus of claim 1 further comprising an electrical power source, an electrical circuit and at least one electrical illuminating element positioned to direct light in a perpendicular direction relative to said elongated concave surface area, wherein a positioning of said positionable elongated member away from said first closed position causes a closing of said electrical circuit to provide an electrical connection between said electrical power source and said illuminating element(s), and a positioning of said thumb-positionable elongated member to said first closed position causes an opening of said electrical circuit and a disconnection between said electrical power source and said illuminating element(s).

9. The oral hygiene and mouth-cosmetic enhancing apparatus of claim 8 wherein said at least one electrical illuminating element is a light bulb.

10. The oral hygiene and mouth-cosmetic enhancing apparatus of claim 8 wherein said at least one electrical illuminating element is a light emitting diode (L.E.D.).

11. The oral hygiene and mouth-cosmetic enhancing apparatus of claim 8 wherein said electrical power source consists of at least one battery and said at least one electrical illuminating element is positioned on the apparatus providing user switchable flashlight-like functionality.

12. The oral hygiene and mouth-cosmetic enhancing apparatus of claim 1 further comprising an electrical power source, an electrical circuit, a finger positionable electrical switch and at least one electrical illuminating element positioned to direct light in a perpendicular direction relative to said elongated concave surface area, wherein one positioning of said switch causes a closing of said electrical circuit to provide an electrical connection between said electrical power source and said illuminating element(s), and another positioning of said switch causes an opening of said electrical circuit and a disconnection between said electrical power source and said illuminating element(s).

13. The oral hygiene and mouth-cosmetic enhancing apparatus of claim 1 wherein said at least one material having a reflective property is comprised of a mirrored glass material.

14. The oral hygiene and mouth-cosmetic enhancing apparatus of claim 1 wherein said at least one material having a reflective property is comprised of a mirrored plastic material.

15. The oral hygiene and mouth-cosmetic enhancing apparatus of claim 1 further comprising said digit-positionable elongated member being pivotably mounted at one end to said casing by a hinge whereby the digit-positionable elongated member is rotatable to extend outwardly from the casing and subsequently be rotated back into a closed position within the casing within a single plane.

16. The oral hygiene and mouth-cosmetic enhancing apparatus of claim 1 further comprising an aperture located adjacent to one end of said casing suitable for releasably attaching said apparatus to attachment means.

17. The oral hygiene and mouth-cosmetic enhancing apparatus of claim 1 further comprising the apparatus incorporating a small electronic device selectable from among memory storage devices or communication devices either of which is equipped to communicate via a wireless or physical connection made with a computer or handheld device.

18. The oral hygiene and mouth-cosmetic enhancing apparatus of claim 1 further comprising a concealable interior storage space and retention means for storing and retaining at least one removable length of dental floss.

19. An oral hygiene and mouth-cosmetic enhancing apparatus comprising:
a digit-positionable elongated member, adapted to slideably fit within a casing and to be slideably positioned in a single plane between a first closed position and a second outwardly extended position, having a length extending up to the length of said casing;
a concealable elongated surface area of said apparatus having a width approximating the width of said casing and a length extending up to the length of the casing, said surface area comprising at least one material having a reflective property;
said thumb-positionable elongated member slideably positionable to extend outward from said casing to said second outwardly extended position to reveal up to all of said elongated upper concave surface area, and slideably positionable to said first closed position to protect and conceal the elongated upper concave surface, and
said concealable elongated surface area and said at least one material thereof, located on a side of said thumb-positionable elongated member having a concavity causing the width of a human mouth to be reflected back to a user when said surface area is pointed at a user's face and said apparatus is held at approximately a typical reading distance.

20. An oral hygiene and mouth-cosmetic enhancing apparatus comprising:
a thumb or digit-positionable elongated member, adapted to slideably fit within a casing and to be slideably positioned in a single plane or axis between a first closed position and a second outwardly extended position, having a length extending up to the length of said casing;
a concealable elongated surface area of said apparatus having a width approximating the width of said casing and a length extending up to the length of the casing, said surface area comprising at least one material having a reflective property;
said thumb or digit positionable elongated member slideably positionable to extend outward from said casing to said second outwardly extended position to reveal up to all of said elongated upper concave surface area, and slideably positionable to said first closed position to protect and conceal the elongated upper concave surface, and
said concealable elongated surface area and said at least one material thereof, are located on an interior wall of said apparatus and have a degree of concavity causing the width of a human mouth to be reflected back to a user when said surface area is pointed at a user's face and said apparatus is held at approximately a typical reading distance.
